(19) United States
(12) Patent Application Publication
(10) Pub. No.: US 2026/0064163 A1
(43) Pub. Date: Mar. 5, 2026

(54) AUTOMATIC SYNCHRONOUS HINGE DEVICE AND ELECTRONIC DEVICE

(71) Applicant: AAC Microtech (Changzhou) Co., Ltd., Changzhou City (CN)

(72) Inventors: Sensen Yang, Changzhou (CN); Haowen Wang, Changzhou (CN); Jinguo Wu, Changzhou (CN); Hongguang Li, Changzhou (CN); Junsheng Wang, Changzhou (CN)

(21) Appl. No.: 19/008,679

(22) Filed: Jan. 3, 2025

Related U.S. Application Data
(63) Continuation of application No. PCT/CN2024/116779, filed on Sep. 4, 2024.

(51) Int. Cl. G06F 1/16

(52) U.S. Cl. CPC G06F 1/1681; G06F 1/1616; G06F 1/1652

(57) ABSTRACT

An automatic synchronous hinge device and an electronic device includes a base, a first driving assembly, a second driving assembly, a first gear transmission assembly, a second gear transmission assembly, and a first hinge assembly. The first driving assembly and the second driving assembly are fixed to the base side by side. The first gear transmission assembly and the second gear transmission assembly are respectively connected with the first driving assembly and the second driving assembly. The first gear transmission assembly is coupled to the second gear transmission assembly to move synchronously. The first hinge assembly is mounted on the base and is driven by the first gear transmission assembly and the second gear transmission assembly to fold or unfold. The automatic synchronous hinge device achieves synchronous opening and closing on two sides, satisfying the user experience of intelligence and technology.

### TECHNICAL FIELD

The present disclosure relates to a technical field of electronic devices, and in particular to an automatic synchronous hinge device and an electronic device.

### BACKGROUND

With development of mobile Internet, a quantity of smart mobile devices continues to rise. Among the smart mobile devices, foldable electronic devices, such as foldable mobile phones, foldable tablets, and laptops, have advantages of portability and large display screens, and are favored by consumers. The foldable electronic devices are foldable through hinges. The foldable electronic devices generally have different use states, such as a fully folded state, a fully unfolded state, and a partially folded state. In order to enable the foldable electronic devices more stable in different partially folding states, a certain amount of rotation resistance and locking force, such as friction resistance, mechanical locking force, and magnetic locking force, are usually artificially increased inside hinges of the foldable electronic devices.

In the related art, an electronic device generally comprises a first body, a second body, and a hinge connecting the first body and the second body. By introducing a motor in the hinge, the hinge is automatically opened and closed by the motor to adjust opening and closing of the first body and the second body, thereby improving an opening and closing experience of the electronic device.

However, a rotational virtual space between the first body and the second body of the electronic device in the related art is large. Furthermore, when no electricity is input to the hinge, the electronic device needs to be folded or unfolded manually, so a user needs to manually apply force to open or close the hinge, making a manual flipping laborious. Especially, when opening the electronic device from the fully folded state or the folly unfolded state, a large locking force needs to be overcome, which is inconvenient for the user and leads to a poor use experience of the electronic device.

Therefore, it is necessary to provide an automatic synchronous hinge device to solve above technical problems.

### SUMMARY

An object of the present disclosure is to provide an automatic synchronous hinge device, whose two output shafts are coupled and driven by a gear group, so that two sides of the automatic synchronous hinge device is opened and closed synchronously, thereby meeting requirements of a user for intelligence and technology.

To achieve the above object, in a first aspect, the present disclosure provides an automatic synchronous hinge device. The automatic synchronous hinge device comprises a base, a first driving assembly, a second driving assembly, a first gear transmission assembly, a second gear transmission assembly, and a first hinge assembly.

The first driving assembly and the second driving assembly are fixed to the base side by side. The first gear transmission assembly is in transmission connection with the first driving assembly. The second gear transmission assembly is in transmission connection with the second driving assembly. The first gear transmission assembly and the second gear transmission assembly are coupled to each other to form synchronous transmission. The first hinge assembly is mounted on the base. The first gear transmission assembly and the second gear transmission assembly are in transmission connection with the first hinge assembly. The first gear transmission assembly and the second gear transmission assembly are configured to drive the first hinge assembly to fold or unfold.

The first hinge assembly comprises a first slider, a second slider, a first fixing block, a first swing arm, a second swing arm, a first connecting piece and a second connecting piece.

The first slider and the second slider are disposed opposite to each other. A first end of the first slider is in transmission connection with the first gear transmission assembly. A first end of the second slider is in transmission connection with the second gear transmission assembly. The first fixing block is fixed to the base and is located on one side of the first slider and the second slider away from the first driving assembly and the second driving assembly.

The first swing arm and the second swing arm are disposed side by side. A first end of the first swing arm close to the second swing arm is rotatably connected with the first fixing block. A first end of the second swing arm close to the first swing arm is rotatably connected with the first fixing block. The first connecting piece and the second connecting piece are located on two opposite sides of the first fixing block. A second end of the first slider is slidably connected with the first connecting piece. A second end of the first swing arm away from the first fixing block is rotatably connected with the first connecting piece. A second end of the second slider is slidably connected with the second connecting piece. A second end of the second swing arm away from the first fixing block is rotatably connected with the second connecting piece.

In one optional embodiment, the first driving assembly comprises a first motor fixed to the base and a first reduction gearbox fixed to the base. The first motor is in transmission connection with the first reduction gearbox. An output end of the first reduction gearbox is in transmission connection with the first gear transmission assembly. The second driving assembly comprises a second motor fixed to the base and a second reduction gearbox fixed to the base. The second motor is in transmission connection with the second reduction gearbox. An output end of the second reduction gearbox is in transmission connection with the second gear transmission assembly.

In one optional embodiment, the automatic synchronous hinge device further comprises a bracket. The bracket is fixed to the base. The first reduction gearbox and the second reduction gearbox are fixed to the bracket.

In one optional embodiment, the first gear transmission assembly comprises a first gear, a second gear, a third gear, a fourth gear, and a first output shaft. The second gear is engaged with the first gear, the third gear is coaxially driven with the second gear. The fourth gear is engaged with the third gear. The first output shaft is fixed to one end of the fourth gear away from the first motor. The first slider is sleeved on the first output shaft. One end of the first output shaft is rotatably connected with the first fixing block.

The second gear transmission assembly comprises a fifth gear, a sixth gear, a seventh gear, an eighth gear, and a second output shaft. The sixth gear is engaged with the fifth gear, the seventh gear is coaxially driven with the sixth gear, the eighth gear is engaged with the seventh gear, and the second output shaft is fixed to one end of the eighth gear away from the first motor. The second slider is sleeved on the second output shaft, and one end of the second output shaft is rotatably connected with the first fixing block. The second gear is coupled to the sixth gear.

In one optional embodiment, a diameter of the first gear is equal to a diameter of the third gear, a diameter of the second gear is equal to a diameter of the fourth gear, and the diameter of the second gear is greater than the diameter of the first gear.

The diameter of the first gear is equal to a diameter of the fifth gear, the diameter of the second gear is equal to a diameter of the sixth gear, the diameter of the third gear is equal to a diameter of the seventh gear, and the diameter of the fourth gear is equal to a diameter of the eighth gear.

In one optional embodiment, the automatic synchronous hinge device further comprises a fixing sheet fixed to the base. The fixing sheet is disposed between the first gear and the third gear, and the fixing sheet is disposed between the fifth gear and the seventh gear.

The first gear, the second gear, the third gear, the fourth gear, the fifth gear, the sixth gear, the seventh gear, and the eighth gear are rotatably connected with the fixing sheet.

In one optional embodiment, the automatic synchronous hinge device further comprises a fixing piece. The fixing piece comprises an arc-shaped surface. The fixing piece is fixed to the base. The fixing sheet is fixedly inserted into the fixing piece. The third gear, the fourth gear, the seventh gear and the eighth gear are rotatably disposed on the arc-shaped surface.

In one optional embodiment, the first reduction gearbox and the second reduction gearbox are three-stage planetary reduction gearboxes.

In one optional embodiment, the first connecting piece comprises a first connecting body, a first T-shaped groove, and a first arc-shaped groove. The first T-shaped groove penetrates through the first connecting body from one side of the first connecting body close to the first fixing block to one side of the first connecting body away from the first fixing block. The second end of the first slider is slidably disposed in the first T-shaped groove, and the second end of the first swing arm is rotatably disposed in the first arc-shaped groove.

The second connecting piece comprises a second connecting body, a second T-shaped groove, and a second arc-shaped groove. The second T-shaped groove penetrates through the second connecting body from one side of the second connecting body close to the first fixing block to one side of the second connecting body away from the first fixing block. The second end of the second slider is slidably disposed in the second T-shaped groove, and the second end of the second swing arm is rotatably disposed in the second arc-shaped groove.

In one optional embodiment, the automatic synchronous hinge device further comprises a second hinge assembly fixed to the base. The second hinge assembly is disposed opposite to the first hinge assembly. A structure of the first hinge assembly is same as a structure of the second hinge assembly.

In one optional embodiment, the automatic synchronous hinge device further comprises a conductive piece. The conductive piece is fixed to the base and is located between the first driving assembly and the second driving assembly. A first end of the conductive piece is electrically connected with the first driving assembly and the second driving assembly, and a second end of the conductive piece is configured to connect to an external power supply.

In a second aspect, the present disclosure provides an electronic device. The electronic device comprises a first body, a second body, a control switch, a screen, a driving module, and the automatic synchronous hinge device mentioned above. The control switch controls the driving module to work. The first body and the second body are oppositely located on two sides of the base. The first body is fixed to one side of the first connecting piece away from the first slider. The second body is fixed to one side of the second connecting piece away from the second slider. The screen is fixedly covered on one side of the first body away from the base, one side of the automatic synchronous hinge device away from the base, and one side of the second body away from the base. The driving module is electrically connected with the first driving assembly and the second driving assembly. The driving module is configured to respectively control the first driving assembly and the second driving assembly to work.

In one optional embodiment, the electronic device further comprises a first support sheet, a second support sheet, and a third support sheet. The first support sheet, the second support sheet, and the third support sheet are disposed side by side. The first support sheet is disposed on the first connecting piece and is located on one side of the first slider away from the base. The second support sheet is fixedly covered on one side of the first fixing block away from the base. The third support sheet is disposed on the second connecting piece and is located on one side of the second slider away from the base. The first support sheet, the second support sheet, and the third support sheet are disposed on one side of the screen close to the base.

Compared with the related art, in the automatic synchronous hinge device disclosed of the present disclosure, the first gear transmission assembly is in transmission connection with the first driving assembly, the second gear transmission assembly is in transmission connection with the second driving assembly, the first gear transmission assembly and the second gear transmission assembly are in transmission connection with the first hinge assembly, and the first gear transmission assembly and the second gear transmission assembly are configured to drive the first hinge assembly to fold or unfold. The first end of the first slider is in transmission connection with the first gear transmission assembly, the first end of the second slider is in transmission connection with the second gear transmission assembly, the first fixing block is fixed to the base and is located on one side of the first slider and the second slider away from the first driving assembly and the second driving assembly, the first end of the first swing arm close to the second swing arm is rotatably connected with the first fixing block, the first end of the second swing arm close to the first swing arm is rotatably connected with the first fixing block, the first connecting piece and the second connecting piece are located on two opposite sides of the first fixing block, the second end of the first slider is slidably connected with the first connecting piece, the second end of the first swing arm away from the first fixing block is rotatably connected with the first connecting piece, the second end of the second slider is slidably connected with the second connecting piece, and the second end of the second swing arm away from the first fixing block is rotatably connected with the second connecting piece. The first driving assembly drives the first slider to slide in the first connecting piece, and the second driving assembly drives the second slider to slide in the second connecting piece, so as to achieve a swinging effect. Meanwhile, the first swing arm and the second swing arm are respectively slidably connected with the first connecting piece and the second connecting piece, so that an opening and closing speed and a duration of the first swing arm is consistent with an opening and closing speed and a duration of the second swing arm disposed opposite to the first swing arm, thereby optimizing a user experience.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a structural schematic diagram of an automatic synchronous hinge device according to a first embodiment of the present disclosure.

FIG. 2 is an exploded structural schematic diagram of an automatic synchronous hinge device according to the first embodiment of the present disclosure.

FIG. 3 is an exploded schematic diagram of a first hinge assembly shown in FIG. 2.

FIG. 4 is a cross-sectional schematic diagram of the automatic synchronous hinge device taken along the line A-A shown in FIG. 1.

FIG. 5 is a structural schematic diagram of a first connecting piece according to the first embodiment of the present disclosure.

FIG. 6 is a structural schematic diagram of a second connecting piece according to the first embodiment of the present disclosure.

FIG. 7 is a perspective structural schematic diagram of an electronic device according to a second embodiment of the present disclosure.

FIG. 8 is an exploded schematic diagram of the electronic device according to the second embodiment of the present disclosure.

FIG. 9 is a cross-sectional schematic diagram of the electronic device taken along the line B-B shown in FIG. 7.

IN THE DRAWINGS

100-automatic synchronous hinge device; 1-base; 2-first driving assembly; 21-first motor; 22-first reduction gearbox; 3-second driving assembly; 31-second motor; 32-second reduction Gearbox; 4-first gear transmission assembly; 41-first gear; 42-second gear; 43-third gear; 44-fourth gear; 45-first output shaft; 5-second gear transmission assembly; 51-fifth gear; 52-sixth gear; 53-seventh gear; 54-eighth gear; 55-second output shaft; 6-first hinge assembly; 61-first slider; 62-second slider; 63-first fixing block; 64-first swing arm; 65-second swing arm; 66-first connecting piece; 661-first connecting body; 662-first T-shaped groove; 663-first arc-shaped groove; 67-second connecting piece; 671-second connecting body; 672-second T-shaped groove; 673-second arc-shaped groove; 7-bracket; 8-fixing piece; 81-arc-shaped surface; 9-fixing sheet; 10-second hinge assembly; 11-conductive piece; 200-electronic device; 201-first body; 202-second body; 203-screen; 204-driving module; 205-lithium battery; 206-first support sheet; 207-second support sheet; 208-third support sheet; 209-control switch.

### DETAILED DESCRIPTION

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

### Embodiment 1

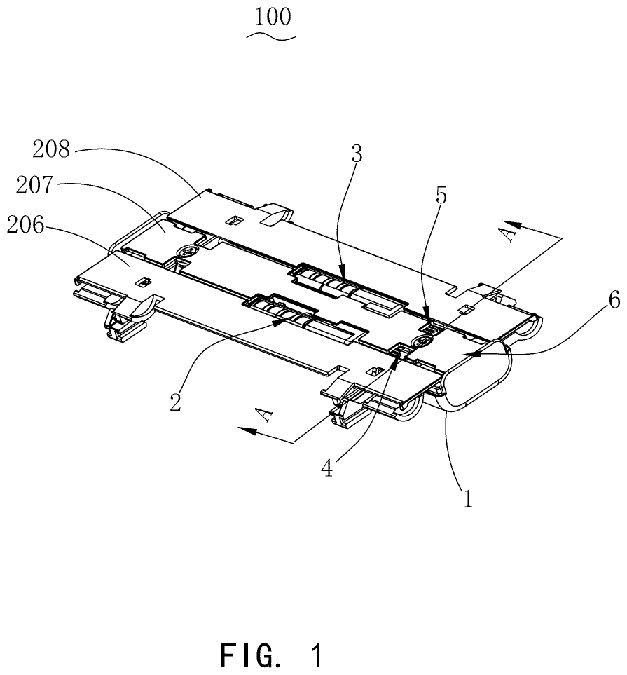

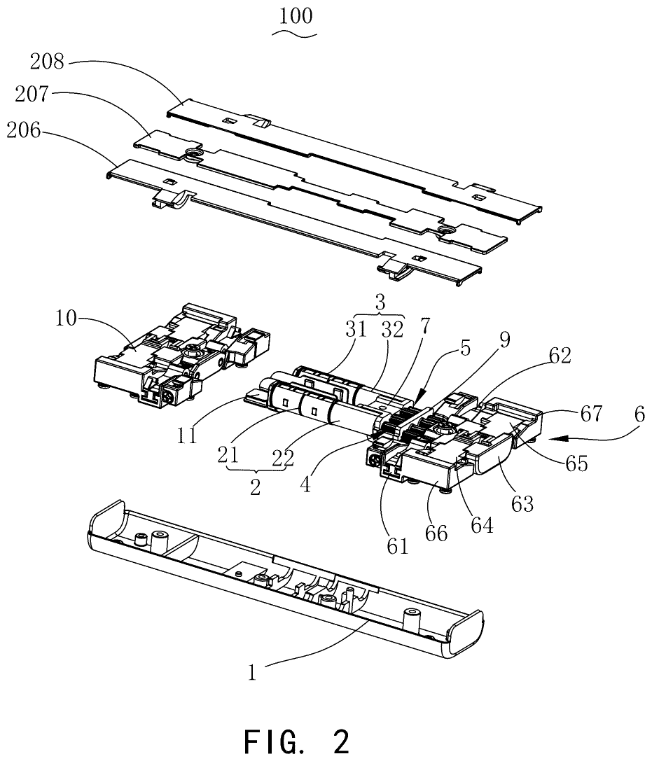

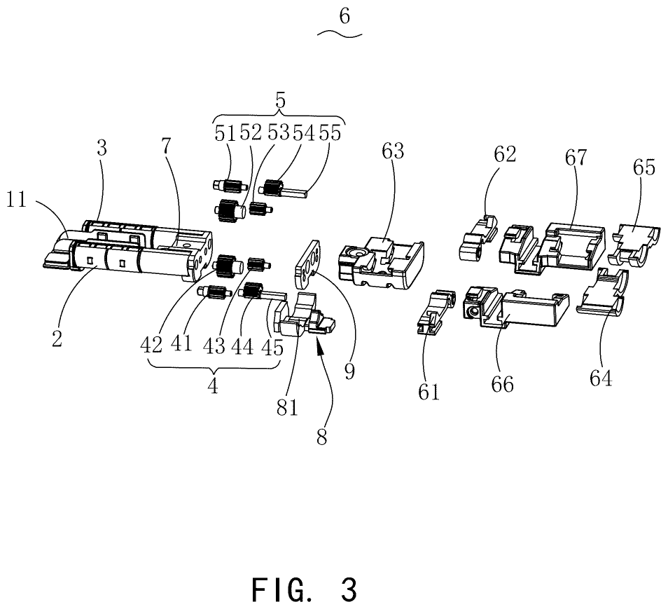

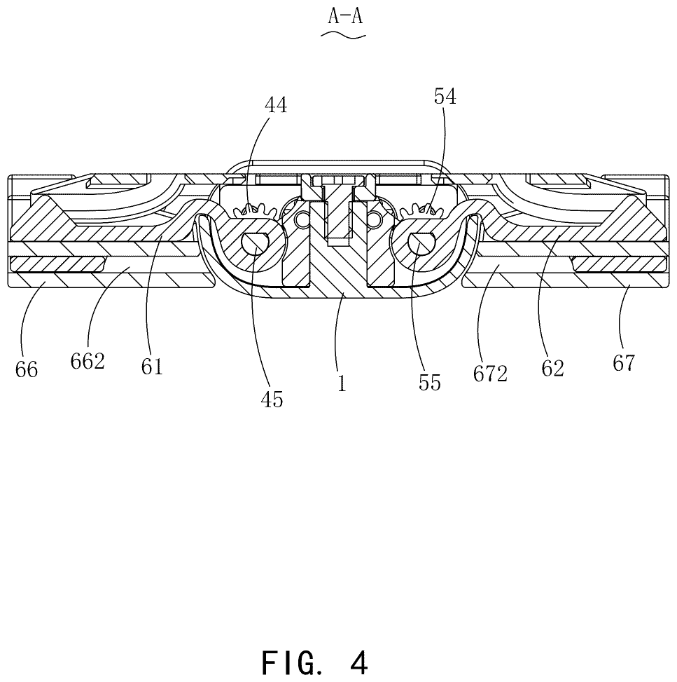

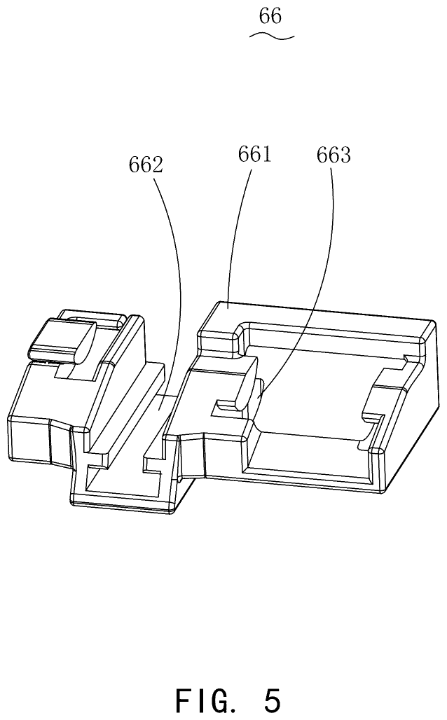

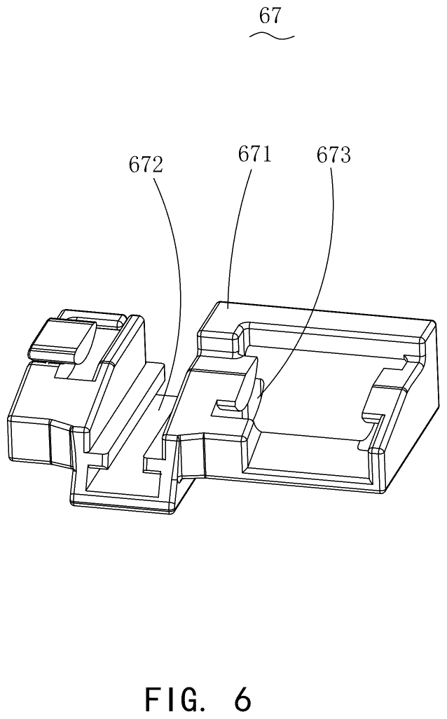

As shown in FIGS. 1-6, the embodiment of the present disclosure provides an automatic synchronous hinge device 100. The automatic synchronous hinge device 100 comprises a base 1, a first driving assembly 2, a second driving assembly 3, a first gear transmission assembly 4, a second gear transmission assembly 5, and a first hinge assembly 6.

The base 1 is configured to support and fix the first driving assembly 2, the second driving assembly 3, the first gear transmission assembly 4, the second gear transmission assembly 5, the first hinge assembly 6, and a first fixing block 63.

The first driving assembly 2 and the second driving assembly 3 are fixed to the base 1 side by side. The first driving assembly 2 and the second driving assembly 3 are disposed side by side along a long axis direction of the base 1.

The first gear transmission assembly 4 is in transmission connection with the first driving assembly 2. The second gear transmission assembly 5 is in transmission connection with the second driving assembly 3. The first gear transmission assembly 4 and the second gear transmission assembly 5 are coupled to each other to form synchronous transmission. The first hinge assembly 6 is mounted on the base 1. The first gear transmission assembly 4 and the second gear transmission assembly 5 are in transmission connection with the first hinge assembly 6. The first gear transmission assembly 4 and the second gear transmission assembly 5 are configured to drive the first hinge assembly 6 to fold or unfold.

The first hinge assembly 6 comprises a first slider 61, a second slider 62, a first fixing block 63, a first swing arm 64, a second swing arm 65, a first connecting piece 66 and a second connecting piece 67. The first slider 61 and the second slider 62 are disposed opposite to each other. A first end of the first slider 61 is in transmission connection with the first gear transmission assembly 4. A first end of the second slider 62 is in transmission connection with the second gear transmission assembly 5. The first gear transmission assembly 4 drives the first slider 61 to flip, and the second gear drive transmission assembly 5 drives the second slider 62 to flip.

The first fixing block 63 is fixed to the base 1 and is located on one side of the first slider 61 and the second slider 62 away from the first driving assembly 2 and the second driving assembly 3.

The first swing arm 64 and the second swing arm 65 are disposed side by side. A first end of the first swing arm 64 close to the second swing arm 65 is rotatably connected with the first fixing block 63. A first end of the second swing arm 65 close to the first swing arm 64 is rotatably connected with the first fixing block 63.

The first connecting piece 66 and the second connecting piece 67 are located on two opposite sides of the first fixing block 63. A second end of the first slider 61 is slidably connected with the first connecting piece 66. A second end of the first swing arm 64 away from the first fixing sheet 9 is rotatably connected with the first connecting piece 66. A second end of the second slider 62 is slidably connected with the second connecting piece 67. A second end of the second swing arm 65 away from the first fixing block 63 is rotatably connected with the second connecting piece 67.

The first driving assembly 2 drives the first gear transmission assembly 4 to move, and the second driving assembly 3 drives the second gear transmission assembly 5 to move. The first gear transmission assembly 4 drives the first slider 61 to flip, and the second gear transmission assembly 5 drives the second slider 62 to flip. The first connecting piece 66 connects the first swing arm 64 and the first slider 61, and the second connecting piece 67 connects the second slider 62 and the second swing arm 65. The first driving assembly 2 and the second driving assembly 3 move synchronously, so that a flip angle of the first slider 61 is consistent with a flip angle of the second slider 62. The first slider 61 and the second slider 62 respectively slide on the first connecting piece 66 and the second connecting piece 67, and then respectively drive the first swing arm 64 and the second swing arm 65 to swing, so as to achieve an effect of synchronous opening and closing of the automatic synchronous hinge device. While the first driving assembly 2 and the second driving assembly 3 are driven in parallel, two output shafts thereof are coupled and driven by a gear group, so that two sides of the automatic synchronous hinge device are able to be opened and closed synchronously, thereby meeting requirements of a user for intelligence and technology.

Moreover, the first driving assembly 2, the second driving assembly 3, the first gear transmission assembly 4, the second gear transmission assembly 5, and the first hinge assembly 6 are disposed on the base 1, so that a composite reduction transmission system based on the drive assemblies disposed in a narrow space of the base 1 obtains a higher reduction ratio, ensuring a torque and an electric drive force required for the automatic synchronous hinge device to open and close. The automatic synchronous hinge device has high integration, small space occupation, and a wider range of application scenarios.

Specifically, the automatic synchronous hinge device 100 reasonably allocates a small radial width, a small axial length, and a longitudinal height space therein, so the automatic synchronous hinge device 100 has a compact structure, high space utilization, high component integration and reliability. Further, an output torque therein provides sufficient opening and closing force for the automatic synchronous hinge device 100.

In the embodiment, the first driving assembly 2 comprises a first motor 21 fixed to the base 1 and a first reduction gearbox 22 fixed to the base 1. The first motor 21 is in transmission connection with the first reduction gearbox 22. An output end of the first reduction gearbox 22 is in transmission connection with the first gear transmission assembly 4. The first motor 21 is connected with the output end of the first reduction gearbox 22, so as to obtain a higher reduction ratio of the composite reduction transmission system, thereby ensuring a torque and an electric driving force required for the first hinge assembly 6 to open and close.

The second driving assembly 3 comprises a second motor 31 fixed to the base 1 and a second reduction gearbox 32 fixed to the base 1. The second motor 31 is in transmission connection with the second reduction gearbox 32. An output end of the second reduction gearbox 32 is in transmission connection with the second gear transmission assembly 5. The second motor 31 is connected with the output end of the second reduction gearbox 32, so as to obtain the higher reduction ratio of the composite reduction transmission system, thereby ensuring a torque and an electric driving force required for the second hinge assembly 6 to open and close.

The first motor 21 and the second motor 31 respectively drive the first reduction gearbox 22 and the second reduction gearbox 32, and the first motor and the second motor are driven in parallel. At the same time, the two output shafts are coupled and driven through the gear transmission assemblies, so that the first swing arm 64 and the second swing arm 65 disposed opposite to the first swing arm 64 achieve synchronous movement, ensuring the opening and closing of the automatic synchronous hinge device 100 stable. In addition, an opening and closing speed and a duration of the first swing arm 64 is consistent with an opening and closing speed and a duration of the second swing arm 65 disposed opposite to the first swing arm 64, thereby meeting the requirements of the user for intelligence and technology.

In the embodiment, the first reduction gearbox 22 and the second reduction gearbox 32 are three-stage planetary reduction gearboxes.

In the embodiment, the automatic synchronous hinge device 100 further comprises a bracket 7. The bracket 7 is fixed to the base 1. The first reduction gearbox 22 and the second reduction gearbox 32 are fixed to the bracket 7. The bracket 7 facilitates mounting and fixing of the first reduction gearbox 22 and the second reduction gearbox 32, so that the first reduction gearbox 22 and the second reduction gearbox 32 have good stability when driven by the first motor 21 and the second motor 31.

In one optional embodiment, the first gear transmission assembly 4 comprises a first gear 41, a second gear 42, a third gear 43, a fourth gear 44, and a first output shaft 45. The second gear 42 is engaged with the first gear 41; the third gear 43 is coaxially driven with the second gear 42. The fourth gear 44 is engaged with the third gear 43. The first output shaft 45 is fixed to one end of the fourth gear 44 away from the first motor 21. The first slider 61 is sleeved on the first output shaft 45. One end of the first output shaft 45 is rotatably connected with the first fixing block 63.

In the embodiment, a diameter of the first gear 41 is equal to a diameter of the third gear 43, a diameter of the second gear 42 is equal to a diameter of the fourth gear 44, and a diameter of the second gear 42 is greater than a diameter of the first gear 41.

The second gear transmission assembly 5 comprises a fifth gear 51, a sixth gear 52, a seventh gear 53, an eighth gear 54, and a second output shaft 55. The sixth gear is engaged with the fifth gear 51, the seventh gear 53 is coaxially driven with the sixth gear 52, the eighth gear 54 is engaged with the seventh gear 53, and the second output shaft 55 is fixed to one end of the eighth gear 54 away from the first motor 21. The second slider 62 is sleeved on the second output shaft 55, and one end of the second output shaft 55 is rotatably connected with the first fixing block 63. The second gear 42 is coupled to the sixth gear 52.

In the embodiment, the diameter of the first gear 41 is equal to a diameter of the fifth gear 51, the diameter of the second gear 42 is equal to a diameter of the sixth gear 52, the diameter of the third gear 43 is equal to a diameter of the seventh gear 53, and the diameter of the fourth gear 44 is equal to a diameter of the eighth gear 54.

Specifically, the first motor 21 drives the first reduction gearbox 22 to reduce speed, the output end of the first reduction gearbox 22 drives the first gear 41 to rotate, the first gear 41 drives the second gear 42 and the third gear 43 to rotate coaxially, and the third gear 43 drives the fourth gear 44 to rotate, so that the first output shaft 45 drives the first slider 61 to slide on the first connecting piece 66, thereby driving the first connecting piece 66 to swing and driving the first swing arm 64 to swing. At the same time, the second motor 31 drives the second reduction gearbox 32 to reduce speed, the output end of the second reduction gearbox 32 drives the fifth gear 51 to rotate, the fifth gear 51 drives the sixth gear 52 and the seventh gear 53 to rotate coaxially, and the seventh gear 53 drives the eighth gear 54 to rotate, so that the second output shaft 55 drives the second slider 62 to slide on the second connecting piece 67, thereby driving the second connecting piece 67 to swing and driving the second swing arm 65 to swing. The second gear 42 is coupled to the sixth gear 52 so that the first motor 21 and the second motor 31 are driven in parallel.

The two output shafts are coupled and driven through the gear transmission assemblies, so that the first swing arm 64 and the second swing arm 65 disposed opposite to the first swing arm 64 achieve synchronous movement, ensuring the opening and closing of the automatic synchronous hinge device 100 stable. In addition, the opening and closing speed and the duration of the first swing arm 64 is consistent with the opening and closing speed and the duration of the second swing arm 65 disposed opposite to the first swing arm 64, thereby meeting the requirements of the user for intelligence and technology.

In the embodiment, the first gear transmission assembly 4 and the second gear transmission assembly 5 are two-stage parallel gear groups. By mounting the above-mentioned components on the base 1, a high transmission ratio torque output structure of dual motor drive with the three-stage planetary reduction gearboxes and the two-stage parallel gear groups is realized in the narrow space, providing sufficient opening and closing force for the automatic synchronous hinge device 100.

In the embodiment, the automatic synchronous hinge device 100 further comprises a fixing sheet 9 fixed to the base 1. The fixing sheet 9 is inserted into the base 1. The fixing sheet 9 is disposed between the first gear 41 and the third gear 43, and the fixing sheet 9 is disposed between the fifth gear 51 and the seventh gear 53. The first gear 41, the second gear 42, the third gear 43, the fourth gear 44, the fifth gear 51, the sixth gear, 52 the seventh gear 53, and the eighth gear 54 are rotatably connected with the fixing sheet 9. The fixing sheet 9 is configured to support the first gear 41 to the eighth gear 54, so that the first gear 41 to the eighth gear 54 have good support stability and stable power transmission during a driving process.

In the embodiment, the automatic synchronous hinge device 100 further comprises a fixing piece 8. The fixing piece 8 comprises an arc-shaped surface 81. The fixing piece 8 is fixed to the base 1. The fixing sheet 9 is fixedly inserted into the fixing piece 8. The third gear 43, the fourth gear 44, the seventh gear 53 and the eighth gear 54 are rotatably disposed on the arc-shaped surface 81. The fixing piece 8 facilitates support and mounting of the first gear transmission assembly 4 and the second gear transmission assembly 5, thus saving a mounting space.

In the embodiment, the first connecting piece 66 comprises a first connecting body 661, a first T-shaped groove 662, and a first arc-shaped groove 663. The first T-shaped groove 662 penetrates through the first connecting body 661 from one side of the first connecting body 661 close to the first fixing block 63 to one side of the first connecting body 661 away from the first fixing block 63. The second end of the first slider 61 is slidably disposed in the first T-shaped groove 662, and the second end of the first swing arm 64 is rotatably disposed in the first arc-shaped groove 663. The first slider 61 is flipped by the first motor 21 to drive the first connecting body 661 to flip and move upward, so that the first swing arm 64 slides in the first arc-shaped groove 663. At the same time, movement of the first slider 61 drives the first connecting body 661 to swing, thereby driving the first swing arm 64 to swing, realizing a folding and opening function of the automatic synchronous hinge device 100.

The second connecting piece 67 comprises a second connecting body 671, a second T-shaped groove 672, and a second arc-shaped groove 673. The second T-shaped groove 672 penetrates through the second connecting body 671 from one side of the second connecting body 671 close to the first fixing block 63 to one side of the second connecting body 671 away from the first fixing block 63. The second end of the second slider 62 is slidably disposed in the second T-shaped groove 672, and the second end of the second swing arm 65 is rotatably disposed in the second arc-shaped groove 673. The second slider 62 is flipped by the second motor 31 to drive the second connecting body 671 to flip and move upward, so that the second swing arm 65 slides in the second arc-shaped groove 673. At the same time, movement of the second slider 62 drives the second connecting body 671 to swing, thereby driving the second swing arm 65 to swing, realizing the folding and opening function of the automatic synchronous hinge device 100.

In the embodiment, the automatic synchronous hinge device 100 further comprises a second hinge assembly 10 fixed to the base 1. The second hinge assembly 10 is disposed opposite to the first hinge assembly 6. A structure of the first hinge assembly 6 is same as a structure of the second hinge assembly 10. The second hinge assembly 10 and the first hinge assembly 6 are respectively disposed at two opposite ends of the base 1, so that the automatic synchronous hinge device 100 has high stability.

In the embodiment, the automatic synchronous hinge device 100 further comprises a conductive piece 11. The conductive piece 11 is fixed to the base 1 and is located between the first driving assembly 2 and the second driving assembly 3. A first end of the conductive piece 11 is electrically connected with the first driving assembly 2 and the second driving assembly 3, and a second end of the conductive piece 11 is configured to connect to an external power supply.

### Embodiment 2

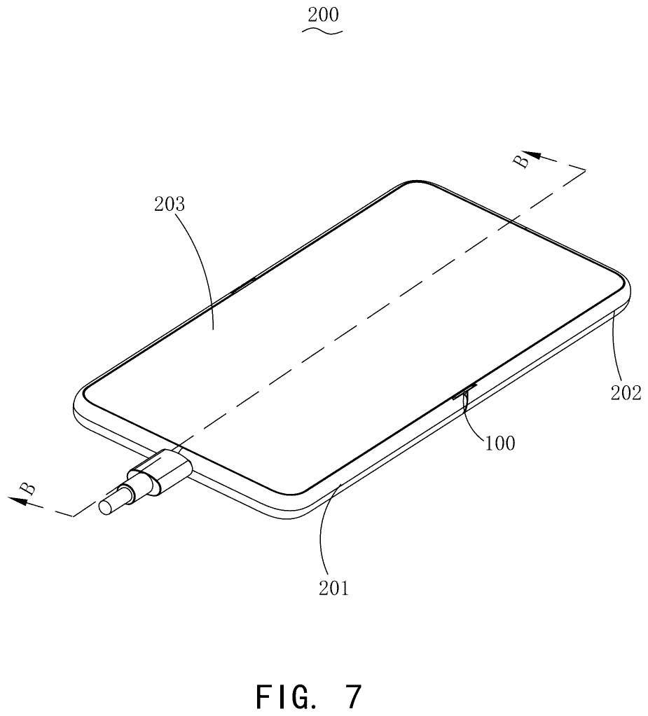

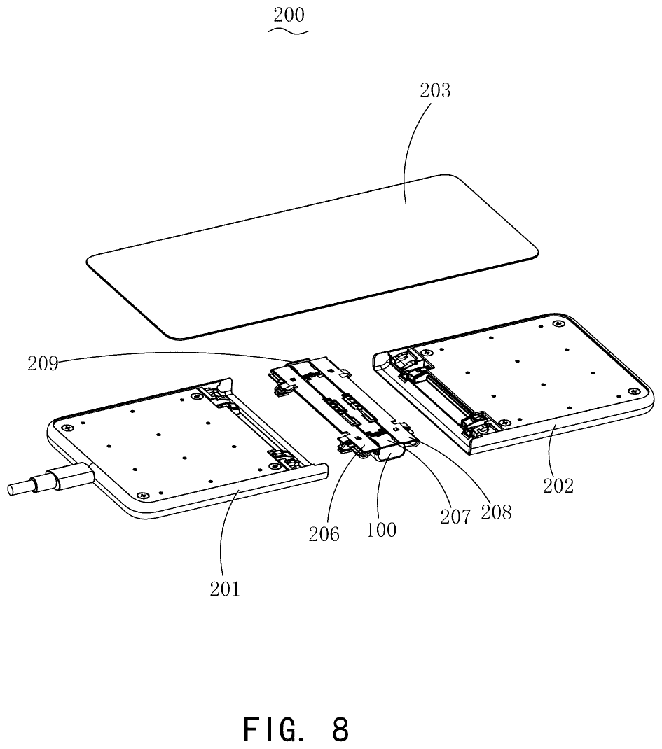

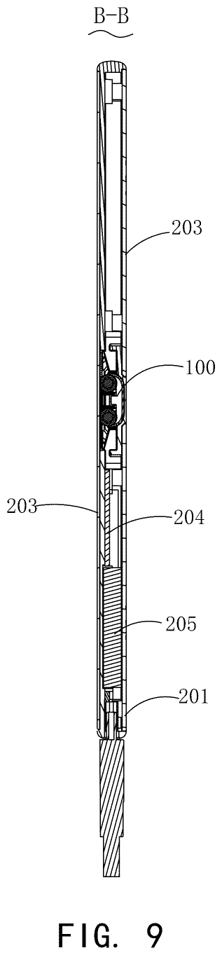

As shown in FIGS. 1-9, the present disclosure provides an electronic device 200. The electronic device 200 comprises a first body 201, a second body 202, a control switch 209, a screen 203, a driving module 204, and the automatic synchronous hinge device 100 in Embodiment 1. The control switch 209 controls the driving module 204 to work. The first body 201 and the second body 202 are oppositely located on two sides of the base 1. The first body 201 is fixed to one side of the first connecting piece 66 away from the first slider 61. The second body 202 is fixed to one side of the second connecting piece 67 away from the second slider 62. The screen 203 is fixedly covered on one side of the first body 201 away from the base 1, one side of the automatic synchronous hinge device 100 away from the base 1, and one side of the second body 202 away from the base 1. The driving module 204 is electrically connected with the first driving assembly 2 and the second driving assembly 3. The driving module 204 is configured to respectively control the first driving assembly 2 and the second driving assembly 3 to work.

The driving module 204 drives the first motor 21 and the second motor 31. The planetary reduction gearboxes and the parallel gear groups increase the transmission ratio of the system to meet a torque requirement of a foldable mobile phone (I.e., the electronic device), and realize the synchronous electric opening and closing of the automatic synchronous hinge device 100 on two sides thereof, which meet the requirements of the user for intelligence and technology.

Optionally, the driving module 204 is a microcontroller, and the first motor 21 and the second motor 31 are driven by the microcontroller, making driving control effect is good.

Specifically, the automatic synchronous hinge device 100 is powered by a lithium battery 205 and is controlled by the driving module 204. The first motor and the second motor that are served as an output end is connected with the driving module 204 through a flexible printed circuit (FPC) board, which ensures that a circuit thereof is not damaged during folding. The first motor 21 and the second motor 31 respectively drive the hinge assemblies to open and close through the output torque of the two reduction gearboxes. The electronic device is automatically opened and closed by pressing a side switch button or by remote control.

In one optional embodiment, the electronic device 200 further comprises a first support sheet 206, a second support sheet 207, and a third support sheet 208. The first support sheet 206, the second support sheet 207, and the third support sheet 208 are disposed side by side. The first support sheet 206 is disposed on the first connecting piece 66 and is located on one side of the first slider 61 away from the base 1. The second support sheet 207 is fixedly covered on one side of the first fixing block 63 away from the base 1. The third support sheet 208 is disposed on the second connecting piece 67 and is located on one side of the second slider 62 away from the base 1. The first support sheet 206, the second support sheet 207, and the third support sheet 208 are disposed on one side of the screen 203 close to the base 1. The first support sheet 206, the second support sheet 207, and the third support sheet 208 are FPC boards, which are easy to mount. Optionally, the second support sheet 207 is fixedly covered on one side of the fixing sheet 9 away from the base 1, and the second support sheet 207 is electrically connected with the conductive piece 11.

Compared with the related art, in the automatic synchronous hinge device disclosed of the present disclosure, the first gear transmission assembly is in transmission connection with the first driving assembly, the second gear transmission assembly is in transmission connection with the second driving assembly, the first gear transmission assembly and the second gear transmission assembly are in transmission connection with the first hinge assembly, and the first gear transmission assembly and the second gear transmission assembly are configured to drive the first hinge assembly to fold or unfold. The first end of the first slider is in transmission connection with the first gear transmission assembly, the first end of the second slider is in transmission connection with the second gear transmission assembly, the first fixing block is fixed to the base and is located on one side of the first slider and the second slider away from the first driving assembly and the second driving assembly, the first end of the first swing arm close to the second swing arm is rotatably connected with the first fixing block, the first end of the second swing arm close to the first swing arm is rotatably connected with the first fixing block, the first connecting piece and the second connecting piece are located on two opposite sides of the first fixing block, the second end of the first slider is slidably connected with the first connecting piece, the second end of the first swing arm away from the first fixing block is rotatably connected with the first connecting piece, the second end of the second slider is slidably connected with the second connecting piece, and the second end of the second swing arm away from the first fixing block is rotatably connected with the second connecting piece. The first driving assembly drives the first slider to slide in the first connecting piece, and the second driving assembly drives the second slider to slide in the second connecting piece, so as to achieve the swinging effect. Meanwhile, the first swing arm and the second swing arm are respectively slidably connected with the first connecting piece and the second connecting piece, so that the opening and closing speed and the duration of the first swing arm is consistent with the opening and closing speed and the duration of the second swing arm disposed opposite to the first swing arm, thereby optimizing the user experience.

The above are only the embodiments of the present disclosure. It should be pointed out that for those of ordinary skill in the art, improvements can be made without departing from the inventive concept of the present disclosure, and these improvements fall within the protection scope of the present disclosure.

What is claimed is:

1. An automatic synchronous hinge device, comprising:
a base;
a first driving assembly;
a second driving assembly;
a first gear transmission assembly;
a second gear transmission assembly; and
a first hinge assembly;
wherein the first driving assembly and the second driving assembly are fixed to the base side by side, the first gear transmission assembly is in transmission connection with the first driving assembly, the second gear transmission assembly is in transmission connection with the second driving assembly, the first gear transmission assembly and the second gear transmission assembly are coupled to each other to move synchronously, the first hinge assembly is mounted on the base, the first gear transmission assembly and the second gear transmission assembly are in transmission connection with the first hinge assembly, and the first gear transmission assembly and the second gear transmission assembly are configured to drive the first hinge assembly to fold or unfold;
wherein the first hinge assembly comprises a first slider, a second slider, a first fixing block, a first swing arm, a second swing arm, a first connecting piece and a second connecting piece;
wherein the first slider and the second slider are disposed opposite to each other, a first end of the first slider is in transmission connection with the first gear transmission assembly, a first end of the second slider is in transmission connection with the second gear transmission assembly, and the first fixing block is fixed to the base and is located on one side of the first slider and the second slider away from the first driving assembly and the second driving assembly;
wherein the first swing arm and the second swing arm are disposed side by side, a first end of the first swing arm close to the second swing arm is rotatably connected with the first fixing block, a first end of the second swing arm close to the first swing arm is rotatably connected with the first fixing block, the first connecting piece and the second connecting piece are located on two opposite sides of the first fixing block, a second end of the first slider is slidably connected with the first connecting piece, a second end of the first swing arm away from the first fixing block is rotatably connected with the first connecting piece, a second end of the second slider is slidably connected with the second connecting piece, and a second end of the second swing arm away from the first fixing block is rotatably connected with the second connecting piece.

2. The automatic synchronous hinge device according to claim 1, wherein the first driving assembly comprises a first motor fixed to the base and a first reduction gearbox fixed to the base, the first motor is in transmission connection with the first reduction gearbox, and an output end of the first reduction gearbox is in transmission connection with the first gear transmission assembly;
wherein the second driving assembly comprises a second motor fixed to the base and a second reduction gearbox fixed to the base, the second motor is in transmission connection with the second reduction gearbox, and an output end of the second reduction gearbox is in transmission connection with the second gear transmission assembly.

3. The automatic synchronous hinge device according to claim 2, wherein the automatic synchronous hinge device further comprises a bracket, the bracket is fixed to the base, and the first reduction gearbox and the second reduction gearbox are fixed to the bracket.

4. The automatic synchronous hinge device according to claim 2, wherein the first gear transmission assembly comprises a first gear, a second gear, a third gear, a fourth gear, and a first output shaft; wherein the second gear is engaged with the first gear, the third gear is coaxially driven with the second gear, the fourth gear is engaged with the third gear, the first output shaft is fixed to one end of the fourth gear away from the first motor, the first slider is sleeved on the first output shaft, and one end of the first output shaft is in transmission connection with the first fixing block;
wherein the second gear transmission assembly comprises a fifth gear, a sixth gear, a seventh gear, an eighth gear, and a second output shaft; wherein the sixth gear is engaged with the fifth gear, the seventh gear is coaxially driven with the sixth gear, the eighth gear is engaged with the seventh gear, the second output shaft is fixed to one end of the eighth gear away from the first motor, the second slider is sleeved on the second output shaft, one end of the second output shaft is rotatably connected with the first fixing block, and the second gear is coupled to the sixth gear.

5. The automatic synchronous hinge device according to claim 4, wherein a diameter of the first gear is equal to a diameter of the third gear, a diameter of the second gear is equal to a diameter of the fourth gear, and the diameter of the second gear is greater than the diameter of the first gear;
wherein the diameter of the first gear is equal to a diameter of the fifth gear, the diameter of the second gear is equal to a diameter of the sixth gear, the diameter of the third gear is equal to a diameter of the seventh gear, and the diameter of the fourth gear is equal to a diameter of the eighth gear.

6. The automatic synchronous hinge device according to claim 5, wherein the automatic synchronous hinge device further comprises a fixing sheet fixed to the base, the fixing sheet is disposed between the first gear and the third gear, and the fixing sheet is disposed between the fifth gear and the seventh gear;
wherein the first gear, the second gear, the third gear, the fourth gear, the fifth gear, the sixth gear, the seventh gear, and the eighth gear are rotatably connected with the fixing sheet.

7. The automatic synchronous hinge device according to claim 6, wherein the automatic synchronous hinge device further comprises a fixing piece, the fixing piece comprises an arc-shaped surface, the fixing piece is fixed to the base, the fixing sheet is fixedly inserted into the fixing piece; wherein the third gear, the fourth gear, the seventh gear and the eighth gear are rotatably disposed on the arc-shaped surface.

8. The automatic synchronous hinge device according to claim 2, wherein the first reduction gearbox and the second reduction gearbox are three-stage planetary reduction gearboxes.

9. The automatic synchronous hinge device according to claim 1, wherein the first connecting piece comprises a first connecting body, a first T-shaped groove, and a first arc-shaped groove, wherein the first T-shaped groove penetrates through the first connecting body from one side of the first connecting body close to the first fixing block to one side of the first connecting body away from the first fixing block, the second end of the first slider is slidably disposed in the first T-shaped groove, and the second end of the first swing arm is rotatably disposed in the first arc-shaped groove;
wherein the second connecting piece comprises a second connecting body, a second T-shaped groove, and a second arc-shaped groove, wherein the second T-shaped groove penetrates through the second connecting body from one side of the second connecting body close to the first fixing block to one side of the second connecting body away from the first fixing block, the second end of the second slider is slidably disposed in the second T-shaped groove, and the second end of the second swing arm is rotatably disposed in the second arc-shaped groove.

10. The automatic synchronous hinge device according to claim 1, wherein the automatic synchronous hinge device further comprises a second hinge assembly fixed to the base, the second hinge assembly is disposed opposite to the first hinge assembly, and a structure of the first hinge assembly is same as a structure of the second hinge assembly.

11. The automatic synchronous hinge device according to claim 1, wherein the automatic synchronous hinge device further comprises a conductive piece, the conductive piece is fixed to the base and is located between the first driving assembly and the second driving assembly, a first end of the conductive piece is electrically connected with the first driving assembly and the second driving assembly, and a second end of the conductive piece is configured to connect to an external power supply.

12. An electronic device, comprising:
a first body;
a second body;
a control switch;
a screen;
a driving module; and
the automatic synchronous hinge device according to claim 1;
wherein the control switch controls the driving module to work, the first body and the second body are oppositely located on two sides of the base, the first body is fixed to one side of the first connecting piece away from the first slider, and the second body is fixed to one side of the second connecting piece away from the second slider;
wherein the screen is fixedly covered on one side of the first body away from the base, one side of the automatic synchronous hinge device away from the base, and one side of the second body away from the base, the driving module is electrically connected with the first driving assembly and the second driving assembly, and the driving module is configured to respectively control the first driving assembly and the second driving assembly to work.

13. The electronic device according to claim 12, wherein the electronic device further comprises a first support sheet, a second support sheet, and a third support sheet;
wherein the first support sheet, the second support sheet, and the third support sheet are disposed side by side, the first support sheet is disposed on the first connecting piece and is located on one side of the first slider away from the base, the second support sheet is fixedly covered on one side of the first fixing block away from the base, the third support sheet is disposed on the second connecting piece and is located on one side of the second slider away from the base, and the first support sheet, the second support sheet, and the third support sheet are disposed on one side of the screen close to the base.
